(19) United States
(12) Patent Application Publication
(10) Pub. No.: US 2006/0190304 A1
(43) Pub. Date: Aug. 24, 2006

(54) Casualty insurance service system for computers and related equipments

(75) Inventors: Johji Kobayashi, Tokyo (JP); Tetsu Kubota, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ADOC INTERNATIONAL Co., Ltd., Tokyo (JP)

(21) Appl. No.: 11/199,231

(22) Filed: Aug. 9, 2005

(30) Foreign Application Priority Data
Feb. 24, 2005 (JP) 2005-49134

(51) Int. Cl. G06Q 40/00; G06F 11/00

(52) U.S. Cl. 705/4; 714/1

(57) ABSTRACT

A casualty insurance service system for a specific computer and related equipment is provided, in which a maintenance contract regarding the computer or related equipment is adopted as an insurance contract, and service for the insurance contract is at least broken down to a client insurance service offered on a remote site and an on-site insurance service so that the next premium can be reduced when there is no fault in the period of insurance and a casualty insurance premium can be levied when there is a fault. The premium for each insurance service is determined by assessment determination means. The assessment determination means comprises assessment means for selecting each item to check regarding said specific computer and related equipment and making an assessment of the selected item; gleaning and storage means for gleaning and storing fault information from said specific computer and related equipment; assessment information means comprising verification information storage means for pre-verifying a computer of the same type sold by a maker and storing information obtained by the pre-verification, capturing means for capturing information from the assessment means, gleaning and storage means and verification information storage means, generation and renewal means for processing the information captured to generate and update assessment information, and memory storage means for storing the generated and updated assessment information; and premium calculation means for using information from said assessment information means to calculate a premium for said specific computer and related equipment.

### FIELD OF THE INVENTION

The present invention relates to a casualty insurance service system for computers and related equipments that insures the maintenance of computers and related equipments and repairs on faults therein, if any.

Conventional insurance contracts are typified by life insurance contracts.

Referring here to an ordinary life insurance contract, after checking up on the insured, a premium rate is assessed and, in consideration of the result of assessment, a term return premium is determined. Optionally, a refund at maturity is supposed to be paid upon expiration of the predetermined term of the life insurance contract.

For contracts for the maintenance of and repairs on computers, related equipments and peripheral equipments, on the other hand, maker contracts generally gain popularity. Maintenance of and repairs on computers, related equipments and peripheral equipments are supposed to be insured for free for one year from the time of purchase of them.

After the lapse of one year, the computer is insured by way of a maintenance contract with an individual maintenance company, not with the maker, and the maintenance contract is generally fixed in terms of contract money. Even when maintenance and repairs are frequently performed within the term of the contract or even when none of maintenance and repairs is performed within the term of the contract, the contract money is the same.

However, how many times maintenance and repairs are necessary varies depending on the computer owned by the client, its related equipment or peripheral equipment or preset LAN conditions. Thus, there are those who are skeptical of current service that such maintenance and repairs are covered by fixed contract money.

There are also maintenance or repair firms who are skeptical of current service where no difference is made between when maintenance and repairs are performed too many times for a single maintenance rate or with difficulty in maintenance and repair and when none of maintenance and repairs is performed within the term of the contract.

JP(A) 2003-263357 shows a remote diagnosis/maintenance system, and a computer and computer software for maintenance centers, which enable a forecast of troubles in ATMs in particular, reduce disabling times during the troubles, and cut down maintenance costs.

However, even such a prior art does not incorporate any maintenance system where differences are made between when maintenance and repairs are performed too many times for a single maintenance rate or with difficulty in maintenance and repairs and when none of maintenance and repairs is performed within the term of the contract.

### SUMMARY OF THE INVENTION

As described above, how many times maintenance and repairs are necessary varies depending on computers owned by clients, their related and peripheral equipments, and preset LAN conditions. Still, in current services, maintenance and repairs are covered by a single, uniform rate. In view of such problems, the primary object of the invention is to set up a system that allows a premium rate regarding troubles or faults to be determined depending on a specific computer, its related or peripheral equipment, and preset LAN conditions, permits the next premium to be reduced in no need of maintenance in a given period of insurance, and imposes a casualty insurance premium in need of maintenance.

Thus, the present invention provides a casualty insurance service system for a specific computer and related equipment, in which a maintenance contract regarding the computer or related equipment is adopted as an insurance contract, and service for said insurance contract is at least broken down to a client insurance service 1 offered on a remote site and an on-site insurance service 2 so that the next premium can be reduced when there is no fault in the period of insurance and a casualty insurance premium can be levied when there is a fault, wherein:

a premium for each insurance service is determined by assessment determination means 12, and

said assessment determination means 12 comprises assessment means 4 for selecting each item to check regarding said specific computer and related equipment and making an assessment of the selected item; gleaning and storage means 5 for gleaning and storing fault information from said specific computer and related equipment; assessment information means 3 comprising verification information storage means 6 for pre-verifying a computer of the same type sold by a maker and storing information obtained by said pre-verification, capturing means 8 for capturing information from said assessment means 4, gleaning and storage means 5 and verification information storage means 6, generation and renewal means 9 for processing the information captured to generate and update assessment information, and memory storage means 10 for storing the generated and updated assessment information; and premium calculation means 11 for using information from said assessment information means 3 to calculate a premium for said specific computer and related equipment (see FIG. 1).

The invention also provides a casualty insurance service system for a specific computer and related equipment, in which a maintenance contract regarding the computer or related equipment is adopted as an insurance contract, and service for said insurance contract is at least broken down to a client insurance service 1 offered on a remote site and an on-site insurance service 2 so that the next premium can be reduced when there is no fault in the period of insurance and a casualty insurance premium can be levied when there is a fault, wherein:

a premium for each insurance service is determined by assessment determination means 12, and

said assessment determination means 12 comprises assessment means 4 for selecting each item to check regarding said specific computer and related equipment and making an assessment of the selected item; gleaning and storage means 5 for gleaning and storing fault information from said specific computer and related equipment; assessment information means 3 comprising verification information storage means 6 for pre-verifying a computer of the same type sold by a maker and storing information obtained by said pre-verification, fault event determination means 7 for determining a fault event in the previous contract term, capturing means 8 for capturing information from said assessment means 4, gleaning and storage means 5, verification information storage means 6 and fault determination means 7, generation and renewal means 9 for processing the information captured to generate and update assessment information, and memory storage means 10 for storing the generated and updated assessment information; and premium calculation means 11 for using information from said assessment information means 3 to calculate a premium for said specific computer and related equipment (see FIG. 2).

In one preferable embodiment of the invention, each of the above casualty insurance service systems further comprises reliability information generation means 13 for obtaining information from said assessment determination means 3 to generate information indicative of the reliability of said specific computer and related equipment such as the type, model and dealer of said specific computer and related equipment; reliability ranking listing means 14 for making a reliability ranking table from the generated reliability information; and browser means 15 for allowing only a specific client to brows the prepared reliability ranking table on demand by way of a communications network (see FIG. 3).

In another preferable embodiment of the invention, each of the above casualty insurance service systems further comprises means 17 for making an automatic diagnosis table available on a WEB by way of a communications network 16; client response means 18 for enabling each client to make a response to the automatic diagnosis table available; and fault diagnosis and estimation means 19 for making a fault diagnosis of the computer and related equipment of the client responding to said automatic diagnosis table and making an estimation for casualty insurance on the basis of the result of response and information form said assessment information means 3 (see FIG. 4).

As described above, how many times maintenance and repairs are necessary varies depending on computers owned by clients, their related and peripheral equipments, and preset LAN conditions. Still, in current services, maintenance and repairs are covered by a single, uniform rate. With the casualty insurance service system for computers and related equipments according to the invention, it is possible to set up a system that allows a premium rate regarding troubles to be determined depending on a specific computer, its related or peripheral equipment, and preset LAN conditions, permits the next premium to be reduced in no need of maintenance in a given period of insurance, and levies a casualty insurance premium in need of maintenance.

### BRIEF DESCRIPTION OF THE DRAWINGS

FIG. 1 is illustrative in schematic of one embodiment of the casualty insurance service system for computers and related equipments according to the invention.

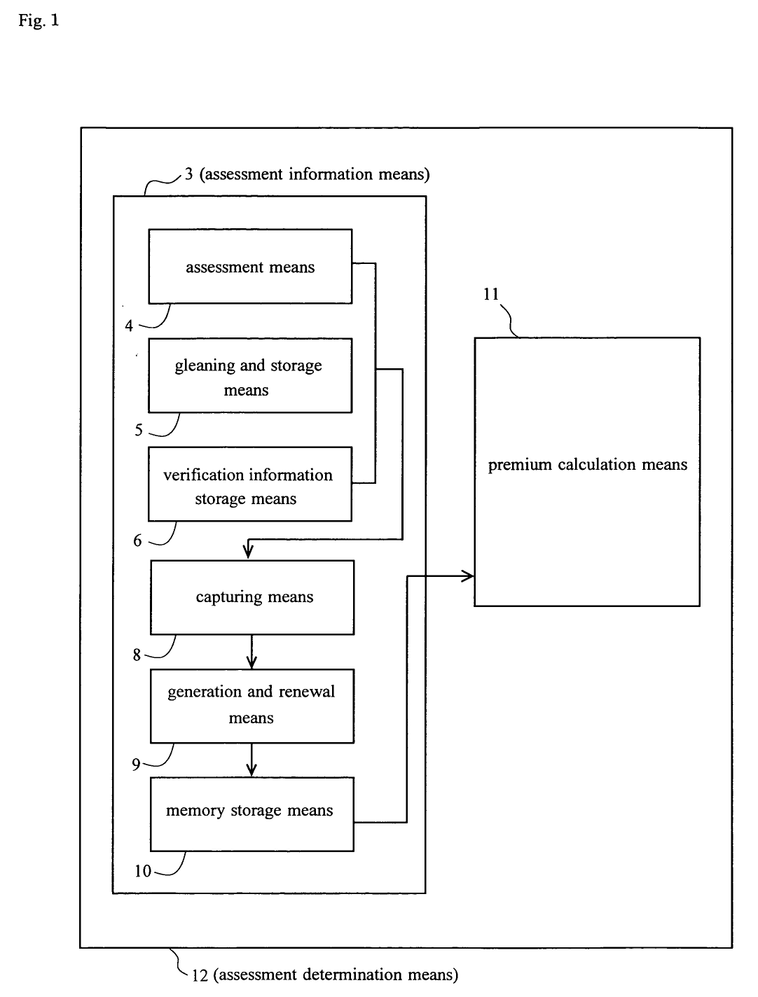

FIG. 2 is illustrative in schematic of another embodiment of the casualty insurance service system for computers and related equipments according to the invention.

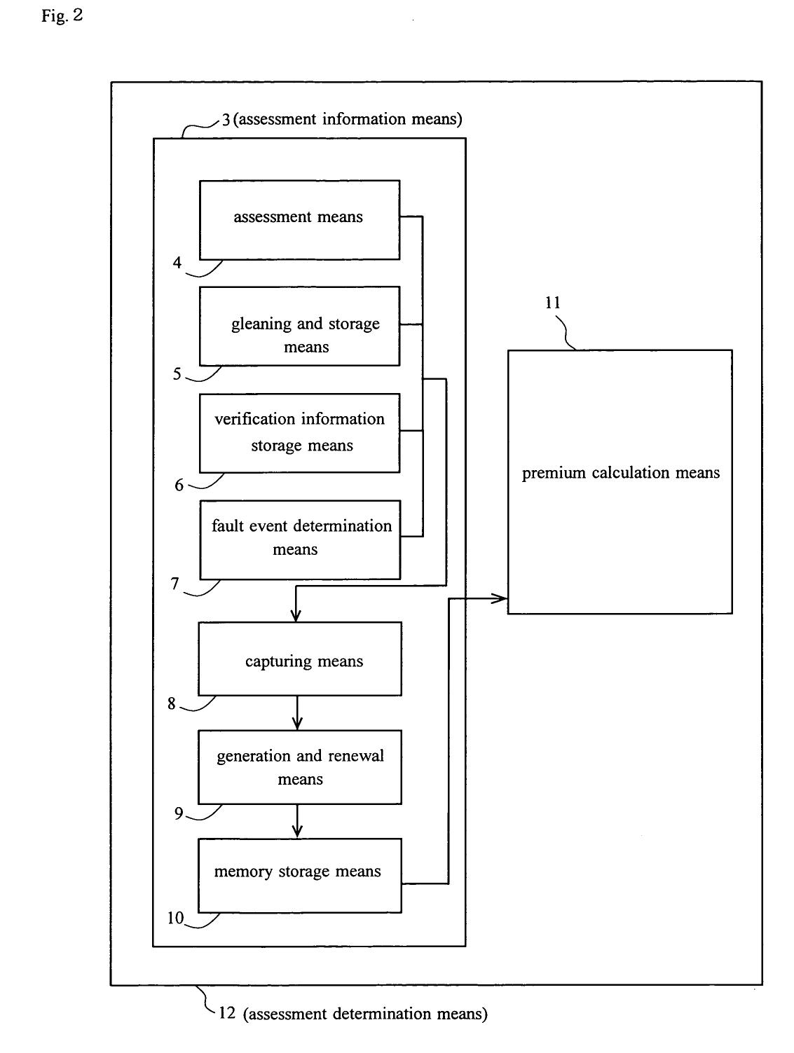

FIG. 3 is illustrative in schematic of yet another embodiment of the casualty insurance service system for computers and related equipments according to the invention.

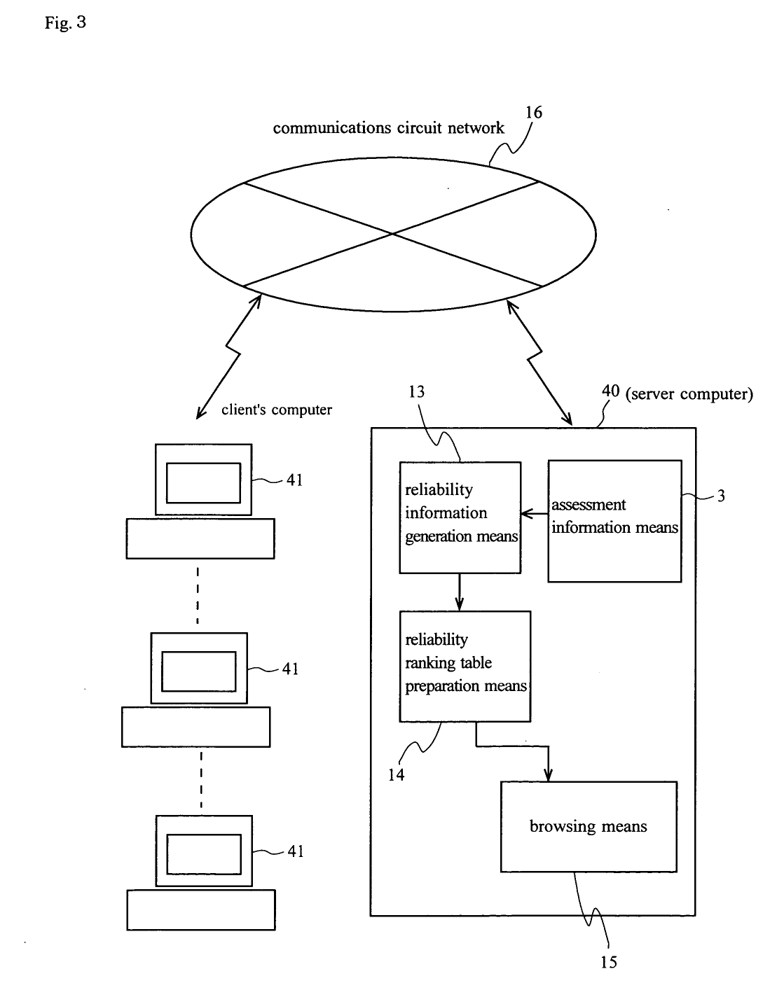

FIG. 4 is illustrative in schematic of a further embodiment of the casualty insurance service system for computers and related equipments according to the invention.

FIG. 5 is a flowchart illustrative in schematic of the casualty insurance service system for computers and related equipments according to the invention.

FIG. 6 is illustrative in schematic of the server computer used in the invention.

FIG. 7 is illustrative in schematic of the assessment sheet used in the invention.

FIG. 8 is illustrative in schematic of the premium calculation sheet used in the invention.

FIG. 9 is illustrative of in what ways faults are thought of.

FIG. 10 is illustrative of the reliability ranking table upon browsing.

FIG. 11 is illustrative of how to make an automatic diagnosis.

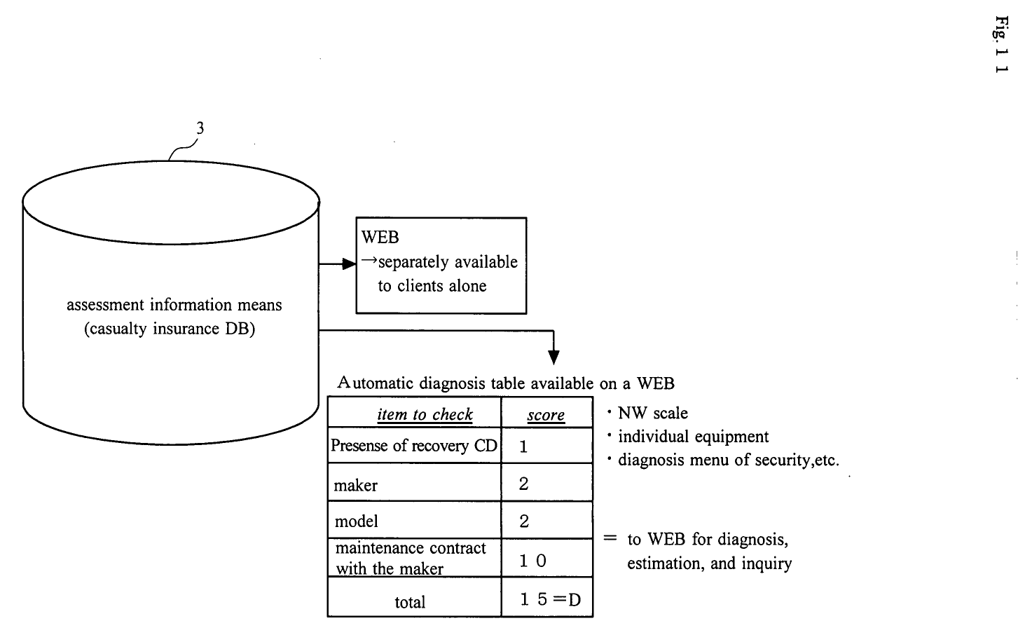

FIG. 12 is illustrative of how to manage various data.

### BEST MODE OF CARRYING OUT THE INVENTION

The best mode of carrying out the invention is now explained with reference to the accompanying drawings.

As previously described, the insured must pay a fixed premium per month to utilize the casualty insurance service system for computers and related equipments according to the invention. The kind of the insurance service offered is generally broken down into client insurance service 1 and an on-site insurance service 2.

More specifically, the client insurance service 1 is to fix a fault on a remote site generally by way of a telephone, the Internet or the like, and the on-site insurance service 2 is to fix a fault on the site.

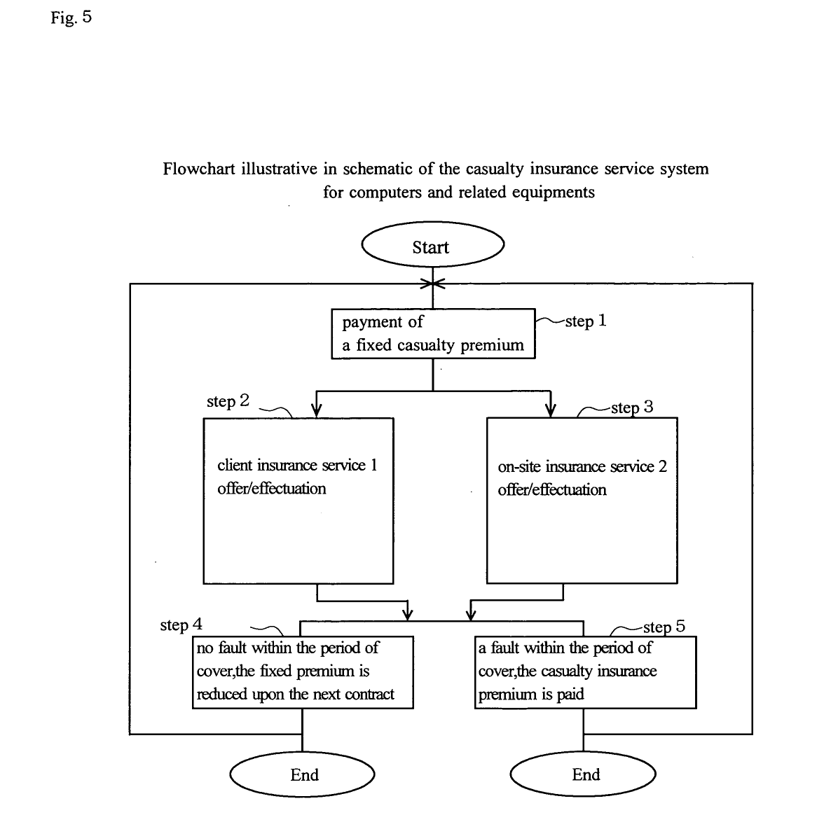

With the casualty insurance service system for computers and related equipments according to the invention, an insurance contract goes into effect by a fixed-term (e.g., the first payment) or lump-sum payment of a fixed casualty insurance premium (step 1), as can be seen from FIG. 5.

Here the insurance service to be contracted is broken down in two kinds, the client insurance service 1 and the on-site insurance service 2; however, the invention is never limited to two such services.

Thus, as the fixed insurance premium is paid, it allows the insured to take out the client insurance service 1 or the on-site insurance service 2 and the system to go into effect (steps 2 and 3).

Where there is a fault in the computer and related equipment to be insured within the period of cover, the casualty insurance premium is paid (step 5), and when there is no fault within the period of cover, the above fixed premium is reduced upon the next contract.

How to determine the above fixed premium is now explained.

The fixed premium concerning the computer and related equipment to be insured according to the invention is determined by assessment determination means 12 comprising assessment information means 3 and premium calculation means 11.

The assessment information means 3 comprises assessment means 4 for making a selection from the items to check regarding the computer and related equipment to be insured and making an assessment of the selected item.

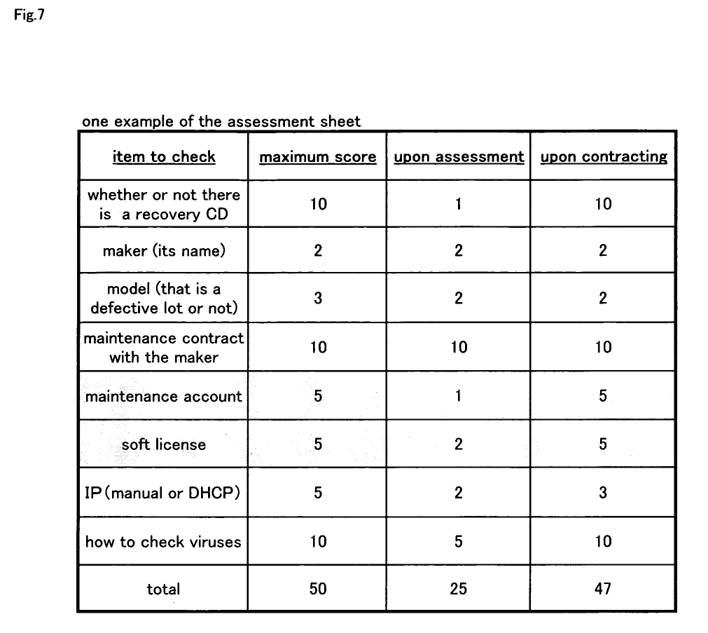

The items to be assessed by the assessment means 4, for instance, are illustrated in FIG. 7. On an assessment sheet typically illustrated in FIG. 7, for instance, there are mentioned “whether or not there is a recovery CD”, “the maker's name”, “the model”, “whether or not there is a maintenance contract with the maker”, “whether or not there is a soft license”, “whether IP is manual or DHCP”, and “whether or not there is a virus check means”.

These items are never restrictive, and so many other items may be added on demand to the system during the actual operation of the system.

Exemplary such items, for instance, could include “whether or not there is an add-on memory”, and “whether or not there is an add-on hard disc”.

Especially in the embodiment of FIG. 7, three items “whether or not there is a recovery CD”, “the maintenance account” and “whether or not there is a soft license” each must gain a perfect score, or else the insured will not take out the insurance according to the invention.

These items to check are vital to restoring normal operation to the computer that the client has.

The maximum (perfect) score of each item has a scale of 2 to 10 points. For instance, the items “whether or not there is a recovery CD”, “whether or not there is a maintenance contract with the maker” and “whether or not there is a virus check method” have each a perfect score of 10 points. Some items have a perfect score of five points, three points or two points. For instance, the items “whether or not there is a maintenance account”, “whether or not there is a soft license” and “whether IP is manual or DHCP”, the item “the model”, and the item “the maker's name” have a perfect scope of five points, three points, and two points, respectively.

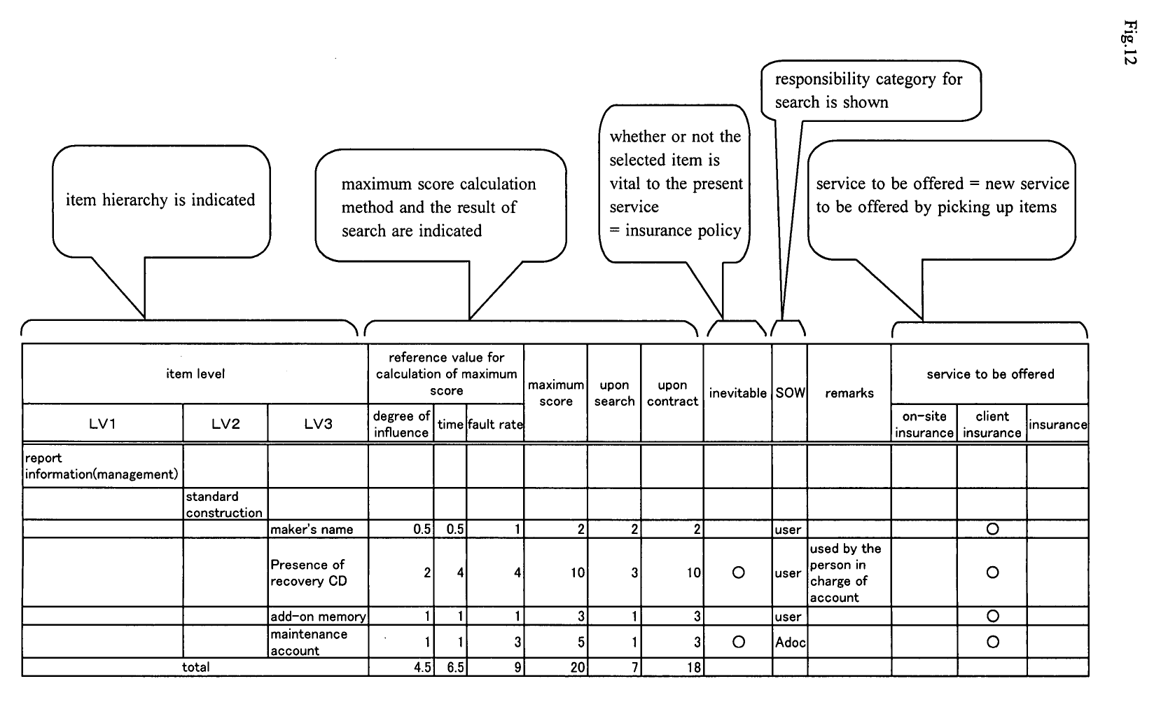

How to calculate the above maximum score is now explained. As can be appreciated from FIG. 12, the maximum score is calculated in terms of the “degree of influence”, the “time taken for recovery” and the “fault rate”.

More specifically, the “degree of influence” refers to the degree of influence of a fault in the computer or related equipment, and has a scale of 10 points as an example. For instance, the item “whether or not there is a recovery CD” has a degree of influence of 2 points. Likewise, the item “the time taken for recovery” has a scale of 10 points, and the computer with no recovery CD is given a 2 on the scale of 10 points. In the case of no recovery CD, the past fault rate has also a scale of 10 points, out of which, for instance, three points are given thereto. Taken these points altogether, the maximum score is calculated at 10.

It is here noted that the “degree of influence”, the “time taken for recovery” and the “fault rate” are optionally renewable; to what degree the fault is recovered is entered in the computer on the site to reflect it upon the estimation of the “degree of influence”, the “time taken for recovery” and the “fault rate”.

In other words, as the “degree of influence”, the “time taken for recovery” and the “fault rate” to be estimated vary, there is a change in the selection of the items to check and the maximum score of each item to check.

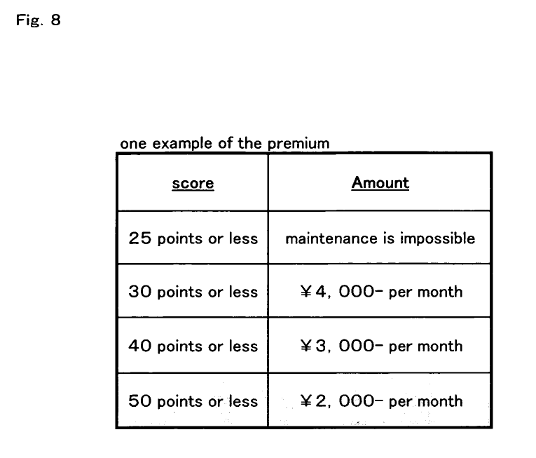

In one embodiment of the invention that is illustrated in FIG. 7 in simplified form, there is a total of 47 points at the time of contract. As those 47 points are applied to a premium calculation sheet that is illustrated in FIG. 8 in simplified form, the premium per month is calculated at 2,000 yen from a column “score of 50 points or less”.

The assessment information means 3 also comprises gleaning and storage means 5 for gleaning and storing therein information about faults in the computer and related equipment to be insured.

For instance, when it comes to a computer, information about the type and model of the computer, what fault occurs in that computer, and what means is used for fixing that fault is entered in the means 5. This information is used for the calculation of the above “fault rate”.

Such fault information is gleaned by entering it in the means 5 either by way of a communications circuit network 16 such as the Internet, or manually.

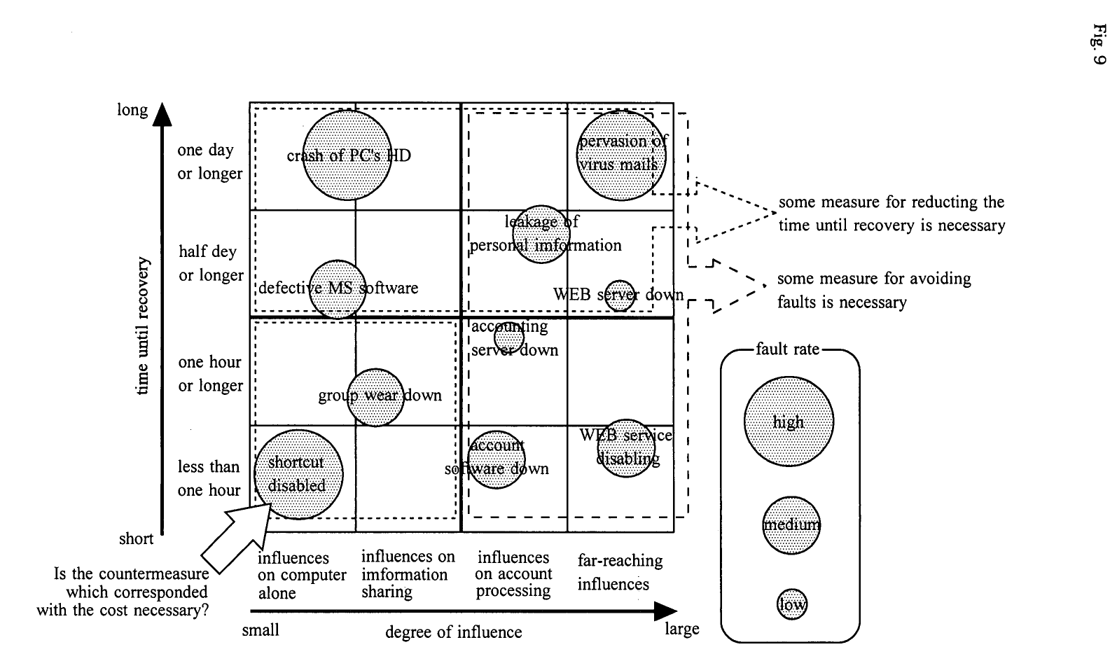

FIG. 9 is illustrative of the relationships among the “degree of influence”, the “time taken for recovery” and the “fault rate”. By reference to FIG. 9, a fault event in a computer, for instance, can be precisely learned. For instance, a shortcut disabling event is indicated as a “high” degree of fault, and occurs at some high frequency. However, the time taken for shortcut recovery is short and the “degree of influence” has influences on the computer alone. Thus, the shortcut circuit event is not fit for the item to check regarding the casualty insurance of the invention.

To the contrary, the “pervasion of viruses” takes much time to restore normal operation to the computer, and has far-reaching influences. Accordingly, preventive measures are necessary for such a fault, and measures for reducing the time taken for fault recovery is needed as well.

Further, the assessment information means 3 comprises verification information storage means 6.

The verification information storage mean 6 has functions of previously verifying a computer of the same type upon request of the maker before sold from the maker to store verification information.

The term “verification” is tantamount to the so-called “medical condition examination” of the human body, and allows the computer to be variously checked up before sale upon request of the maker to have an idea of what failure the computer or its related equipment will run into.

The assessment information means 3 also comprises fault event determination means 7 for determining a fault event.

The fault event determination means 7 for determining a fault event finds out whether or not there was a fault in the computer and related equipment to be insured at the time of the previous contract, and if any special fault is not found, the next premium is to be reduced.

Reference numeral 28 stands for information capturing means, where there is captured information from the assessment means 4, gleaning and storage means 5, verification information storage means 6 and fault event determination means 7. The information captured by the capturing means 8 is processed by the generation and renewal means 9 to generate and update the assessment information.

Memory storage means 10 stores the information generated or updated by the generation and renewal means 9.

Various pieces of information from the assessment information means 3 are used to calculate a specific premium for the computer and related equipment to be covered by premium calculation means 31.

Information from the assessment information means 3 is processed and analyzed by reliability information generation means 13 to generate information indicative of the reliability of the computer and related equipment such as their type, model and dealer.

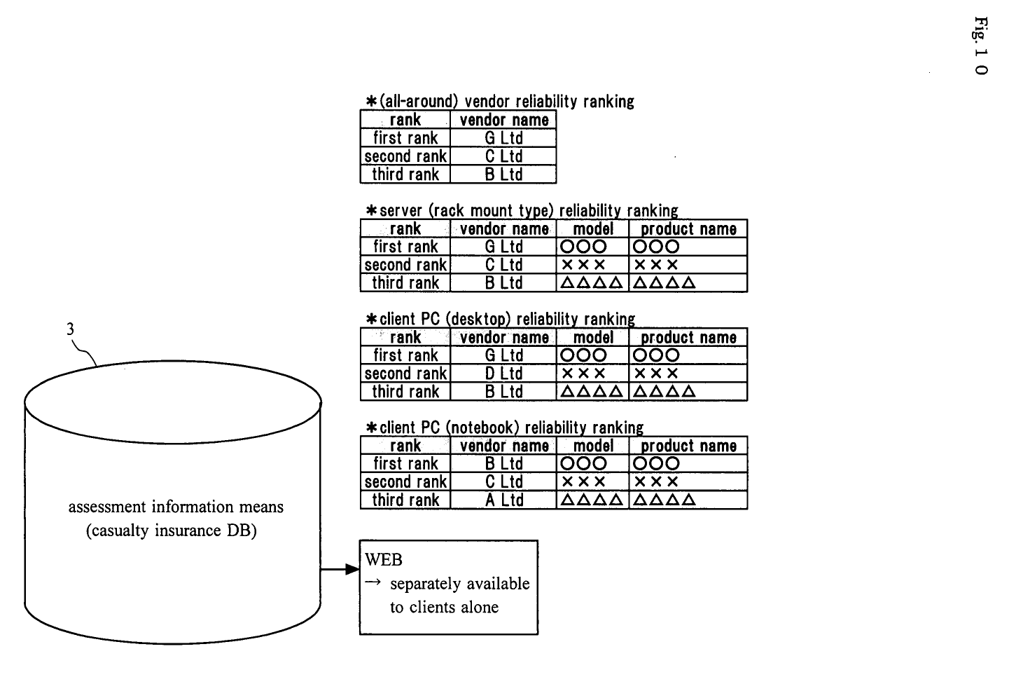

The generated reliability information is then processed and analyzed to make a reliability ranking table 38 by reliability ranking table preparation means 14 (see FIG. 10).

The thus obtained reliability ranking table 38 is available to only the client on demand by way of browsing means 5 via the communications circuit network 16 such as the Internet.

According to the invention, the casualty insurance service system is connected to the computer 41 of each client by way of the communications circuit network 16 such as the Internet, so that the quotations of the automatic diagnosis and recovery of a fault in the computer 41 and related equipment can be presented on a WEB appearing on the monitor of the computer 41 of each client.

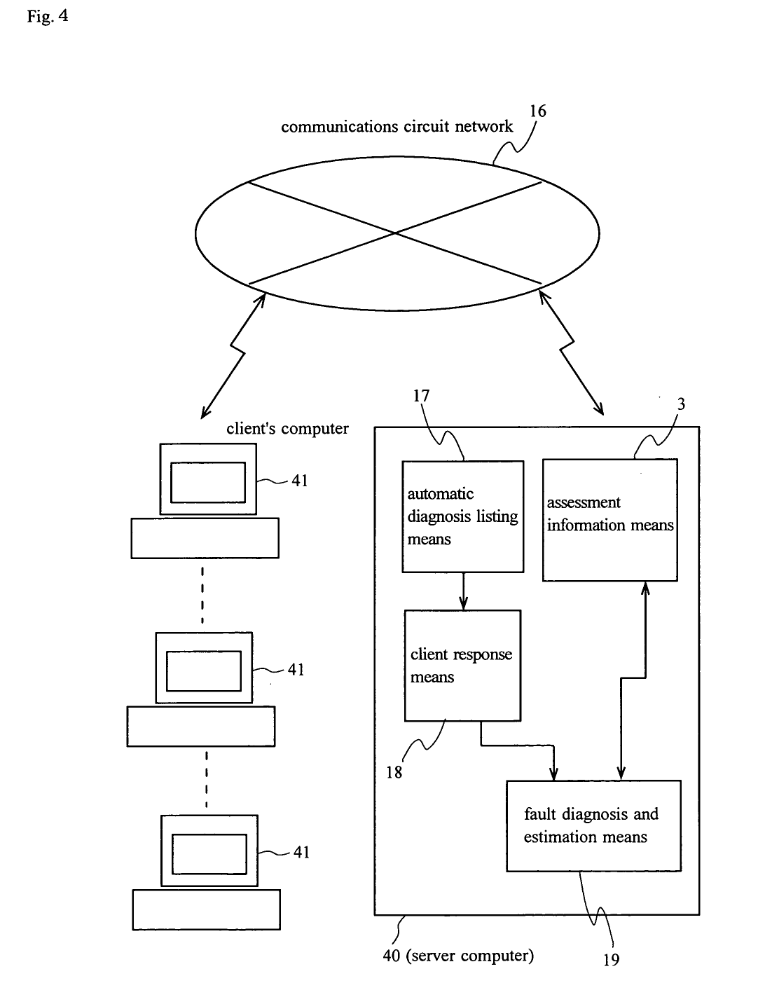

That is, as can be understood from FIG. 4, a server computer 40 that makes an automatic diagnosis of a fault in the computer 41 and related equipment of each client by way of the Internet comprises automatic diagnosis listing means 17 and client response means 18, and an automatic diagnosis table formed by the automatic diagnosis listing means 17 is allowed to appear on the WEB on the monitor of each computer 41.

The automatic diagnosis table on the WEB appearing on the monitor of the computer 41 of each client is used in such a way as to permit each client to respond to each item on her or his own personal computer.

Upon responding to each item, the response is sent to the server computer 40 by way of the communications circuit network 16 such as the Internet.

At the server computer 40, the above response is received and processed by the client response means 18, so that the result of processing is processed and analyzed together with the information from the assessment information means 3 by fault diagnosis and estimation means 19.

Then, the result of such processing and analysis is processed by the fault diagnosis and estimation means 19, and sent as a automatic diagnosis and estimation quotation to the client on demand.

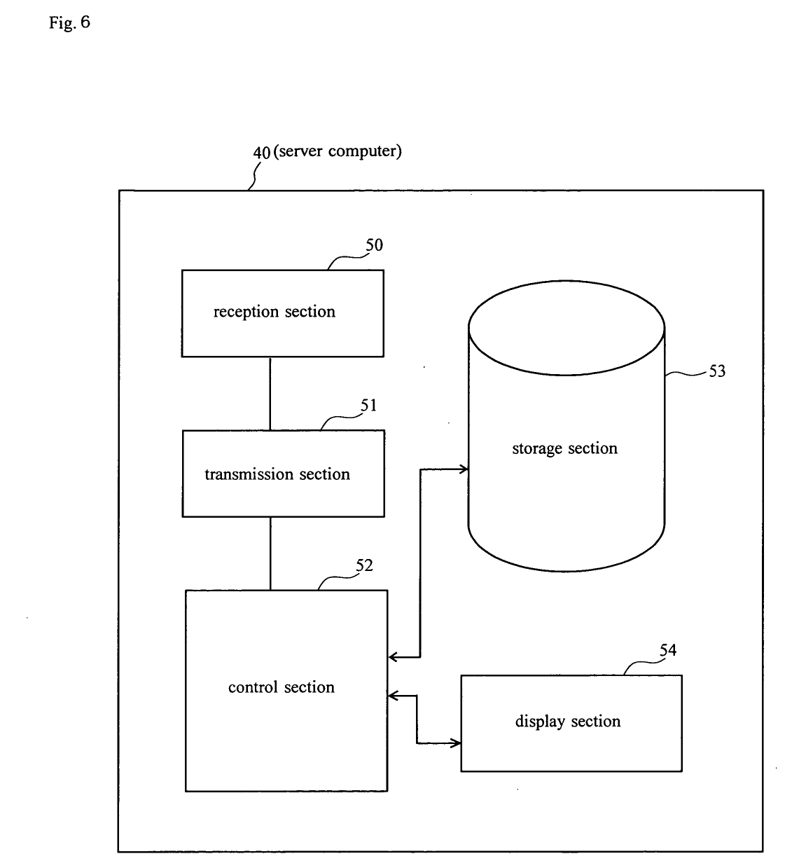

It is here noted that as shown in FIG. 6, the server computer 40 comprises a reception section 50, a transmission section 51, a control section 52 including a CPU or the like and a storage section 53 including a hard disc. In the server computer 40, the control 52 and storage section 53 correspond to the assessment determination means 12 for the calculation of premiums, the reliability information generation means 13 for generating the reliability ranking table by way of the Internet, the reliability ranking table preparation means 14, the automatic diagnosis listing means 17 for making an automatic diagnosis of the computer owned by a desired client, making that automatic diagnosis and an estimation of fault recovery to generate information and send the information to the client, the client response means 18 or the like.

1. A casualty insurance service system for a specific computer and related equipment, in which a maintenance contract regarding the computer or related equipment is adopted as an insurance contract, and service for said insurance contract is at least broken down to a client insurance service offered on a remote site and an on-site insurance service so that the next premium can be reduced when there is no fault in the period of insurance and a casualty insurance premium can be levied when there is a fault, wherein:
a premium for each insurance service is determined by assessment determination means, and
said assessment determination means comprises assessment means for selecting each item to check regarding said specific computer and related equipment and making an assessment of the selected item; gleaning and storage means for gleaning and storing fault information from said specific computer and related equipment; assessment information means comprising verification information storage means for pre-verifying a computer of the same type sold by a maker and storing information obtained by said pre-verification, capturing means for capturing information from said assessment means, gleaning and storage means and verification information storage means, generation and renewal means for processing the information captured to generate and update assessment information, and memory storage means for storing the generated and updated assessment information; and premium calculation means for using information from said assessment information means to calculate a premium for said specific computer and related equipment.

2. A casualty insurance service system for a specific computer and related equipment, in which a maintenance contract regarding the computer or related equipment is adopted as an insurance contract, and service for said insurance contract is at least broken down to a client insurance service offered on a remote site and an on-site insurance service so that the next premium can be reduced when there is no fault in the period of insurance and a casualty insurance premium can be levied when there is a fault, wherein:
a premium for each insurance service is determined by assessment determination means, and
said assessment determination means comprises assessment means for selecting each item to check regarding said specific computer and related equipment and making an assessment of the selected item; gleaning and storage means for gleaning and storing fault information from said specific computer and related equipment; assessment information means comprising verification information storage means for pre-verifying a computer of the same type sold by a maker and storing information obtained by said pre-verification, fault event determination means for determining a fault event in the previous contract term, capturing means for capturing information from said assessment means, gleaning and storage means, verification information storage means and fault determination means, generation and renewal means for processing the information captured to generate and update assessment information, and memory storage means for storing the generated and updated assessment information; and premium calculation means for using information from said assessment information means to calculate a premium for said specific computer and related equipment.

3. The casualty insurance service system according to claim 1, which further comprises reliability information generation means for obtaining information from said assessment determination means to generate information indicative of the reliability of said specific computer and related equipment such as the type, model and dealer of said specific computer and related equipment; reliability ranking listing means for making a reliability ranking table from the generated reliability information; and browser means for allowing only a specific client to brows the prepared reliability ranking table on demand by way of a communications circuit network.

4. The casualty insurance service system according to claim 1, which further comprises means for making an automatic diagnosis table available on a WEB by way of a communications network; client response means for enabling each client to make a response to the automatic diagnosis table available; and fault diagnosis and estimation means for making a fault diagnosis of the computer and related equipment of the client responding to said automatic diagnosis table and making an estimation for casualty insurance on the basis of the result of response and information from said assessment information means.

5. The casualty insurance service system according to claim 2, which further comprises reliability information generation means for obtaining information from said assessment determination means to generate information indicative of the reliability of said specific computer and related equipment such as the type, model and dealer of said specific computer and related equipment; reliability ranking listing means for making a reliability ranking table from the generated reliability information; and browser means for allowing only a specific client to brows the prepared reliability ranking table on demand by way of a communications circuit network.

6. The casualty insurance service system according to claim 2, which further comprises means for making an automatic diagnosis table available on a WEB by way of a communications network; client response means for enabling each client to make a response to the automatic diagnosis table available; and fault diagnosis and estimation means for making a fault diagnosis of the computer and related equipment of the client responding to said automatic diagnosis table and making an estimation for casualty insurance on the basis of the result of response and information from said assessment information means.

7. The casualty insurance service system according to claim 3, which further comprises means for making an automatic diagnosis table available on a WEB by way of a communications network; client response means for enabling each client to make a response to the automatic diagnosis table available; and fault diagnosis and estimation means for making a fault diagnosis of the computer and related equipment of the client responding to said automatic diagnosis table and making an estimation for casualty insurance on the basis of the result of response and information from said assessment information means.
